(19) United States
(12) Patent Application Publication
(10) Pub. No.: US 2010/0288139 A1
(43) Pub. Date: Nov. 18, 2010

(54) FOOD SLICING DEVICE

(75) Inventors: Chi Ta LI, Tainan City (TW); Chieh-Wen Lin, Tainan City (TW); Junlin Chen, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/781,109

(22) Filed: May 17, 2010

(30) Foreign Application Priority Data
May 15, 2009 (CN) 200920138389.0

(51) Int. Cl. A47J 43/07

(52) U.S. Cl. 99/538; 30/295

(57) ABSTRACT

The present invention discloses a food slicing device. In the present invention, the opening of the horizontal shell disposed horizontally is a material output port; a material-input tube is disposed on the upper part of the shell, and the material-input tube extends upward to form a material-input port; a cutter unit with the same direction to the opening disposed inside the horizontal shell; the rotating shaft protrudes out of the bottom of the shell; a protective cover is disposed on the material output port, whose ring is inserted in the material output port, and the top portion of said protective cover extends outward to form a tongue portion for covering up the opening of said material output port of the shell. So the problem that fingers of consumer are injured accidentally by rotating blade of the cutter is solved.

### FIELD OF THE INVENTION

The present invention relates to a device in kitchen, especially a food slicing device which can cut vegetable or fruit into the shapes of filament, strip and flake.

### BACKGROUND OF THE INVENTION

The conventional food slicing device comprises a horizontal tube-shaped shell and a tube-shaped cutter. The opening of the shell is a material output port; a material-input tube is disposed on the upper part of the shell, and the material-input tube extends upward to form a material-input port. A cutter unit with the same direction to the opening disposed is in the horizontal shell. The rotating shaft of the cutter unit extends out of the bottom of shell. Put fruit or vegetable in the material-input tube, and use cylindrical push rod to press food in the cutter unit, and then rotate the rotating shaft in order to make the cutter unit to rotate. The cutter unit cuts the food into the shapes of filament, strip or flake. And the filaments, strips or flakes of food can be expelled from the material output port of the shell, when the cutter unit is rotating. Food can be cut into the shapes of filament, strip or flake by changing different cutter unit. Because the filaments, strips or flakes of food can not be expelled from the cutter unit completely, when some consumers is using the food slicing device, they may use chopstick to take the remained filaments, strips or flakes of food out of the cutter unit; so the fingers of consumers may be injured accidentally by the rotating blade. Therefore, the improved food slicing device is designed into the shape of a conical tube with opening on the large end, and the cutter unit is designed into the shape of a conical tube with opening on the large end. The axis of the shell and the cutter unit is sloping downward, and the upper part of the periphery of the cutter unit is vertical to the axis of the material-input port. A universal rotating joint is disposed on the rotating shaft of the cutter unit, and the other end of the universal rotating joint protrudes out of the bottom of the shell. But the food slicing device could not avoid the problem that the fingers of consumers may be injured accidentally by rotating blade when they put their fingers into the shell.

### SUMMARY OF THE INVENTION

The purpose of the present invention is to provide a kind of food slicing device, and to prevent the fingers of consumers from being injured accidentally by rotating blade when consumer put their fingers into the shell.

The technical solution applied by the present invention is:

A food slicing device comprises:

a horizontal shell disposed with a material output port in horizontal direction for discharging food stuff;

a material-input tube disposed on the upper part of said shell;

a material-input tube extended upwards from said material-input tube;

a cutter unit with the same direction to said opening disposed inside said shell; wherein the rotating shaft of said cutter unit extends out of the bottom of said shell;

a protective cover disposed on the opening of said material output port; wherein said protective cover further comprises a ring which can be inserted in the opening of said material output port and the top portion of said protective cover extends outward to form a tongue portion for covering up the opening of said material output port.

A step unit is disposed inside said protective cover, and a first inserting part is disposed on the peripheral of the step for connecting, to a second inserting part disposed on the inside peripheral of said material output port.

Said protective cover is transparent.

In a preferred embodiment, a hinge unit is disposed on the opening of said material output port for connecting said protective cover.

Said shell and said cutter unit are in the shape of conical tube with opening on the large end; the axis of said shell and said cutter unit are sloping downward, and the upper part of the periphery of said cutter unit is vertical to the axis of said material input port; a universal rotating joint is disposed on the rotating shaft of the cutter unit, and the other end of the universal rotating joint protrudes out of the bottom of the shell. With the structure of the invention, food can be cut faster and more efficiently, and the filaments, strips and flakes of food can be expelled from the shell completely.

Especially, the downward sloping angle of the axis of said shell and said cutter unit is between 10 degrees and 23 degrees in order to facilitate expelling the filaments, strips and flakes of food and rotating the universal rotating joint.

The food slicing device of the present invention has a protective cover disposed on the material output port of the shell in order to prevent fingers of consumers from being injured accidentally by rotating blade, and prevent fruit and vegetable offcut from being thrown everywhere by the centrifugal force from the high-speed rotating blade. The protective cover is inserted in the material output port to be fixed to it. The connection between the protective cover and the material output port is stable and the connection can be installed or dismantled quickly. The protective cover is transparent, so consumers can at any time observe the situation of discharging the filaments, strips and flakes of food when using the food slicing device. A hinge is disposed on the material output port in order to connect to the protective cover, so after uncovering the protective cover, consumer can change the cutter unit conveniently.

### BRIEF DESCRIPTION OF THE DRAWINGS

FIG. 1 illustrates a front structure view of the food slicing device of the present invention in a preferred embodiment.

FIG. 2 illustrates a three-dimension exploded view of the food slicing device in FIG. 1.

FIG. 3 illustrates a sectional view of the food slicing device in FIG. 1.

FIG. 4 illustrates a side structure view of the food slicing device in FIG. 1 and a sectional view of part of the food slicing device in FIG. 1.

FIG. 5 illustrates an enlarged view of part A in FIG. 3.

FIG. 6 illustrates an enlarged view of part B in FIG. 4.

FIG. 7 illustrates a structure view of the food slicing device in FIG. 1, when the protective cover is uncovered.

### DESCRIPTION OF SPECIFIC EMBODIMENTS

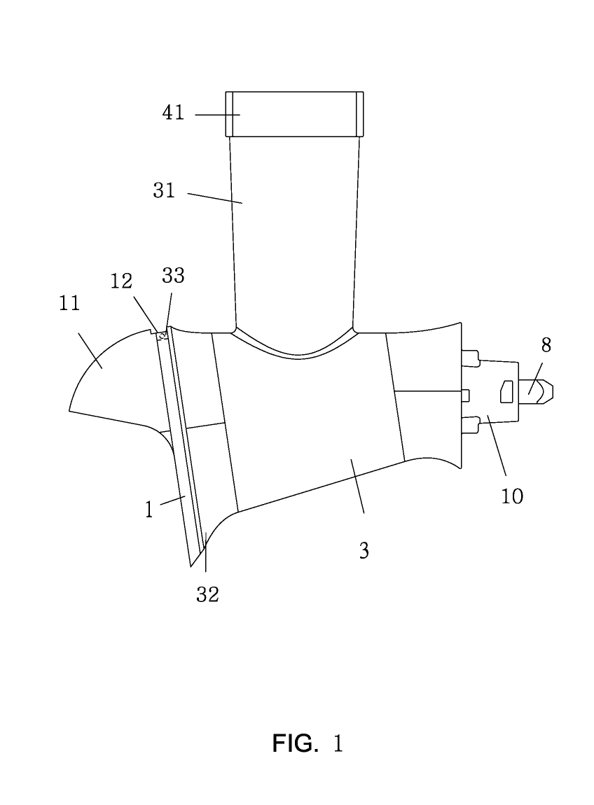

Referring to FIG. 1 to FIG. 6, in the present invention in a preferred embodiment, the food slicing device comprises a protective cover 1, a cutter unit 2, a shell 3, a push rod 4, a bush 5, a front universal rotating shaft 6, an install rack 7, a back universal rotating shaft 8, a sleeve 9 and a positioning pedestal 10.

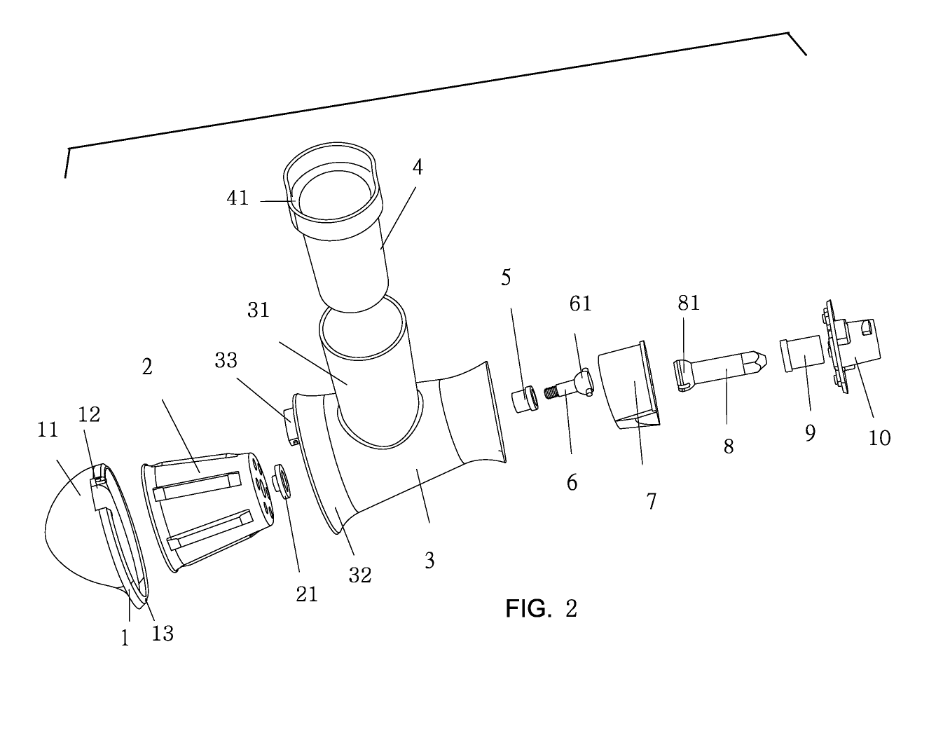

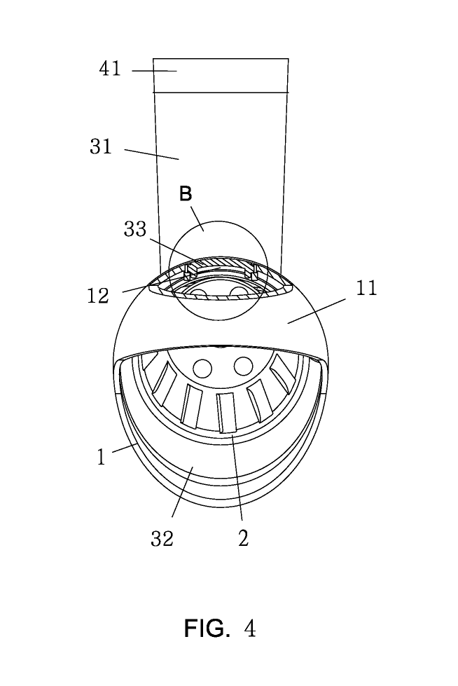

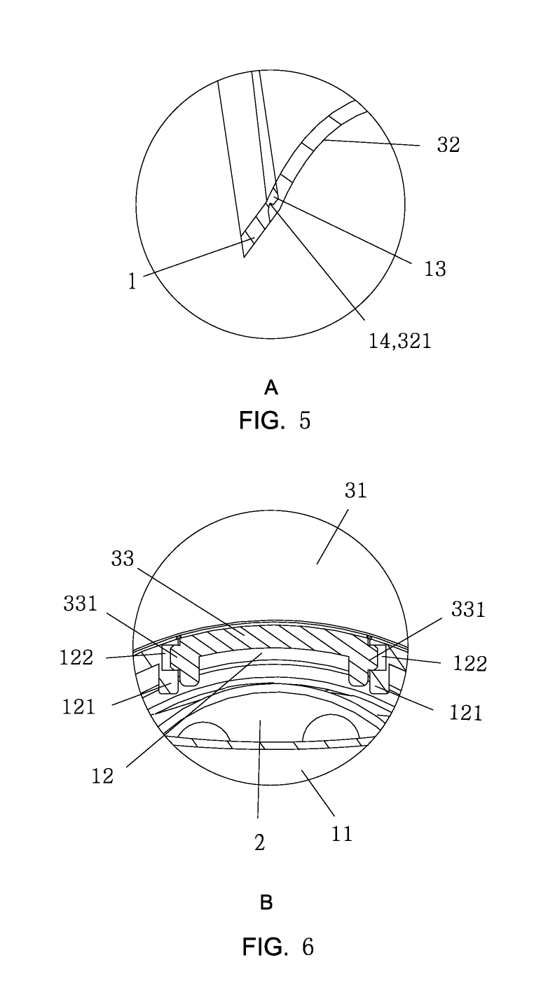

The protective cover 1 is made of transparent plastic. A tongue portion 11 extending outward is disposed on the ring of the protective cover 1. A hole 12 is disposed on the central line of the tongue portion 11, referring to FIG. 2. The two sides of the hole 12 extend inward and form a stopper 121 respectively, and the inside surface of each stopper 121 has a socket 122, referring to FIG. 4 and FIG. 6. A step 13 is disposed in the body, referring to FIG. 2 and FIG. 5. Under the circle face of the step 13, a inserting part—a hollow 14.

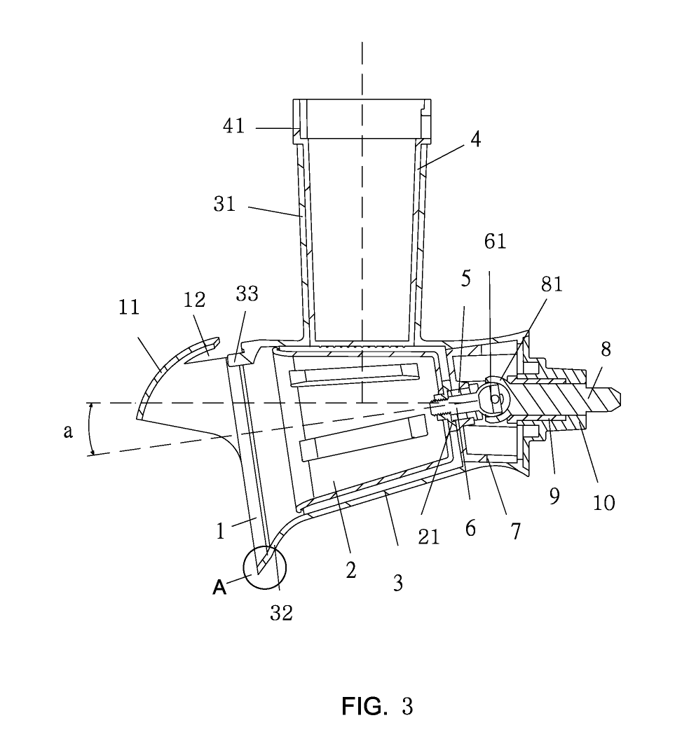

The cutter unit 2 is a metal conical tube with opening on the large end, and several cutting edges 21 are disposed in the periphery of the cutter unit 2. A inside screw pedestal is welded to the center of the bottom of the cutter unit 2, referring to FIG. 3. The shapes and sizes of different cutting edges in different cutter unit are different from each other, so consumers can use them to cut food into the shapes of filament, strip and flake.

The horizontal shell 3 is made by casting molding into an iron three-way pipe, and the front part of the body of it disposed horizontally is a conical tube with opening on the large end, which contains the cutter unit 2. Referring to FIG. 3, actually, the bottom of the front part of the horizontal shell 3 is the bottom of the install rack 7. The back part of the horizontal shell 3 is a conical pipe with opening on the large end in order to contain the install rack 7, the bush 5 and universal rotating joint comprised of the front universal rotating shaft 6 and the back universal rotating shaft 8. A material-input tube is disposed on the upper part of the front part of the body of the horizontal shell 3, and a material-input port 31 extends upward from the material-input tube of the horizontal shell 3; the opening 32 of the front part of the body of the horizontal shell 3 is a material output port. Referring to FIG. 2, a lug 33 extending outward is disposed on the upper part of the opening 32. Referring to FIG. 4 and FIG. 6, the two sides of the lug 33 extend outward and respectively form a short shaft 331. Referring to FIG. 5, convex points 321 are disposed on the inside circle face of the opening 32 of the horizontal shell 3, which are the inserting part corresponding to the hollow 14 of the protective cover 1.

The push rod is a plastic multi-diameter cylindrical tube, and the diameter of the large end of it is larger than the outside diameter of the material-input port 31 of the horizontal shell 3, and the diameter of the small end of it is smaller than the inside diameter of the material-input port 31 of the horizontal shell 3. The length of the small part of the push rod 4 equals to that of the material-input port 31.

The install rack is an iron box made by casting molding. Referring to FIG. 3, the bush 5 is disposed on the pipe in the center of the bottom of the install rack 7. The bush 5 is covered on the middle of the front universal rotating shaft 6, and the semi-sphere 61 on the back of the front universal rotating shaft 6 has a “-”-shaped hinge pin. The axis of the front universal rotating shaft 6 (the axis of the cutter unit 2 and the front part of the body of the horizontal shell 3) is sloping downward relative to the upper part of the periphery of the cutter unit 2 (horizontal line), and the downward sloping angle is between 10 degrees and 23 degrees. The front part of the back universal rotating shaft 8 is a sphere socket 81 which can contain the semi-sphere 61 on the back of the front universal rotating shaft 6, and the two sides of the sphere socket 81 have a “U”-shaped slot respectively. The “-” -shaped hinge pin of the semi-sphere 61 of the front universal rotating shaft 6 is inserted into the “U”-shaped slots of sphere socket 81 of the back universal rotating shaft 8, so the rotating angle of the back universal rotating shaft 8 can be adjusted freely.

The positioning pedestal 10 is disposed on the open back of the horizontal shell 3. The sleeve 9 is disposed in the center hole of the positioning pedestal 10. The middle of the back universal rotating shaft 8 is in the sleeve 9, and the back of the back universal rotating shaft 8 protrudes out of the back of the positioning pedestal 10.

The cutter unit 2 is put into the horizontal shell 3 through the opening 32 of the horizontal shell 3, and the opening of the cutter unit 2 is in the direction of the opening of the horizontal shell 3; with a thread of a screw, the front part of the front universal rotating shaft 6 is fixed in the inside screw pedestal 22 under the cutter unit 2, so the cutter unit 2 is rotary fixed in the horizontal shell 3.

The protective cover 1 is disposed on the opening 32 of the horizontal shell 3. Referring to FIG. 4 and FIG. 6, the short shafts 331 on the two sides of the lug 33 on the opening 32 are respectively inserted in the socket 133 in the two sides of the hole 12 of the horizontal shell 3 in order to form a hinge connection between the protective cover 1 and the horizontal shell 3. The step 13 on the ring of the protective cover 1 is inserted in the opening 32 of the horizontal shell 3, and the convex points 321 on the inside circle face of the opening 32 of the horizontal shell 3 are stuck in the hollow 14 under the circle face of the step 13, referring FIG. 5. The tongue portion 11 extending outward is disposed on the upper part of the body of protective cover 1 in order to cover the material output port of the horizontal shell 3.

When using the food slicing device, consumers should firstly put food into the material-input port 31, and then use the push rod 2 to press the food to the periphery of the cutter unit 2, at last make the back universal rotating shaft 8 to rotate the front universal rotating shaft 6 in order to make the cutter unit 2 to rotate. The cutter unit 2 cuts the food into the shapes of filament, strip and flake. And the filaments, strips and flakes of the food can be expelled from the material output port of the horizontal shell 3 by the rotation of the cutter unit 2. Because of the protective cover 1, the fingers of consumers could not reach in the material output port of the horizontal shell 3 so that the fingers are prevented from being injured by the cutter unit 2.

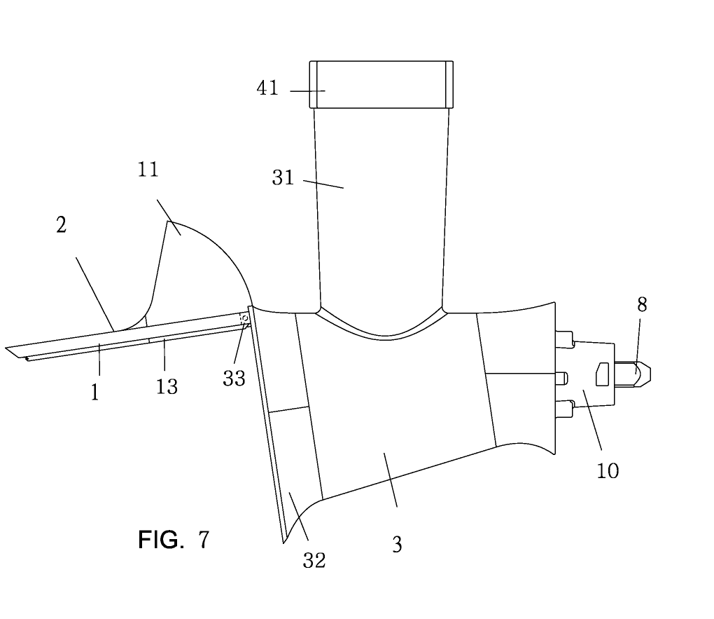

When it is necessary to change cutter unit 2, consumers can hold the lower part of the protective cover 1 and separate the hollow 14 under the step 13 from the convex points 321 on the inside circle face of the opening 32 of the horizontal shell 3. Then uncover the protective cover 1, referring to FIG. 7, and put the hand into the horizontal shell 3 to rotate the cutter unit 2 in the opposite direction. The inside screw pedestal 22 under the cutter unit 2 is separated from the front part with a thread of a screw of the front universal rotating shaft 6. After that, the cutter unit 2 can be taken from the opening 32 of the horizontal shell 3.

In other designs, the present invention has the following essential structure: the opening of the horizontal shell is used as material output port; a material-input tube is disposed on the upper part of the periphery of the horizontal shell, and a material-input port extending upward is disposed on the material-input tube of the horizontal shell. A tube cutter unit with the same direction to the opening disposed inside the horizontal shell; the rotating shaft of the cutter unit extends out of the bottom of the horizontal shell. A protective cover is disposed on the material output port of the horizontal shell, and the tongue portion extending upward on the upper part of the protective cover covers the material output port of the horizontal shell.

The body of the protective cover and the material output port of the horizontal shell can be connected together by a thread of a screw, or they can be connected by inserting at least two pins disposed on the inside circle face of the material output port of the horizontal shell into corresponding “L” shaped slots disposed in the circle face of the step on the protective cover.

All above is just a preferred embodiment of the present invention, so the present invention should not be limited in these embodiments. In a word, it should be understood that according to the scope of the present invention and the content of the description, all the various equivalent modifications and alterations will be apparent in the scope and spirit of this invention. Therefore, the scope and sprit of the invention is limited only by the claims.

What is claimed is:

1. A food slicing device comprises:
a horizontal shell disposed with a material output port in horizontal direction for discharging food stuff;
a material-input tube disposed on the upper part of said shell;
a material-input tube extended upwards from said material-input tube;
a cutter unit with the same direction to said opening disposed inside said shell; wherein the rotating shaft of said cutter unit extends out of the bottom of said shell;
a protective cover disposed on the opening of said material output port; wherein said protective cover further comprises a ring which can be inserted in the opening of said material output port and the top portion of said protective cover extends outward to form a tongue portion for covering up the opening of said material output port.

2. The food slicing device according to claim 1, wherein a step unit is disposed inside said protective cover, and a first inserting part is disposed on the peripheral of the step for connecting, to a second inserting part disposed on the inside peripheral of said material output port.

3. The food slicing device according to claim 2, wherein said protective cover is transparent.

4. The food slicing device according to claim 1, wherein a hinge unit is disposed on the opening of said material output port for connecting said protective cover.

5. The food slicing device according to claim 4, wherein said shell and said cutter unit are in the shape of conical tube with opening on the large end; the axis of said shell and said cutter unit are sloping downward, and the upper part of the periphery of said cutter unit is vertical to the axis of said material input port; a universal rotating joint is disposed on the rotating shaft of the cutter unit, and the other end of the universal rotating joint protrudes out of the bottom of the shell.

6. The food slicing device according to claim 5, wherein the downward sloping angle of the axis of said shell and said cutter unit is between 10 degrees and 23 degrees.

7. The food slicing device according to claim 2, wherein a hinge unit is disposed on the opening of said material output port for connecting said protective cover.

8. The food slicing device according to claim 3, wherein a hinge unit is disposed on the opening of said material output port for connecting said protective cover.

9. The food slicing device according to claim 7, wherein said shell and said cutter unit are in the shape of conical tube with opening on the large end; the axis of said shell and said cutter unit are sloping downward, and the upper part of the periphery of said cutter unit is vertical to the axis of said material input port; a universal rotating joint is disposed on the rotating shaft of the cutter unit, and the other end of the universal rotating joint protrudes out of the bottom of the shell.

10. The food slicing device according to claim 8, wherein said shell and said cutter unit are in the shape of conical tube with opening on the large end; the axis of said shell and said cutter unit are sloping downward, and the upper part of the periphery of said cutter unit is vertical to the axis of said material input port; a universal rotating joint is disposed on the rotating shaft of the cutter unit, and the other end of the universal rotating joint protrudes out of the bottom of the shell.

11. The food slicing device according to claim 9, wherein the downward sloping angle of the axis of said shell and said cutter unit is between 10 degrees and 23 degrees.

12. The food slicing device according to claim 10, wherein the downward sloping angle of the axis of said shell and said cutter unit is between 10 degrees and 23 degrees.
